(19) United States
(12) Patent Application Publication
(10) Pub. No.: US 2009/0266482 A1
(43) Pub. Date: Oct. 29, 2009

(54) HIGH-STRENGTH POLYURETHANE ADHESIVE

(76) Inventors: Helga Garmann, Westhausen (DE); Claus-Heinrich Puck, Ellwangen (DE); Gerhard Mosshammer, Bopfingen (DE)

Correspondence Address: Henkel Corporation, 10 Finderne Avenue, Bridgewater, NJ, 08807, US

(21) Appl. No.: 12/463,680

(22) Filed: May 11, 2009

Related U.S. Application Data
(63) Continuation of application No. PCT/EP2007/059626, filed on Sep. 13, 2007.

(30) Foreign Application Priority Data
Nov. 15, 2006 (DE) 10 2006 054 197.7
Nov. 15, 2006 (DE) 10 2006 054 197.9

(51) Int. Cl. B32B 37/12; C08L 75/04

(52) U.S. Cl. 156/275.5; 525/453

(57) ABSTRACT

The invention relates to a method for adhesively bonding substrates together that contains irregularities on the surface of the substrates. The adhesive is particularly suitable for adhesively bonding thin flexible substrates onto a rigid substrates.

### CROSS REFERENCE TO RELATED APPLICATIONS

This application is a continuation of PCT/EP2007/059626 filed Sep. 13, 2007, which claims the benefit of DE 10 2006 054 197.9, filed Nov. 15, 2006, the complete disclosures of which are hereby incorporated by reference in their entirety.

### FIELD OF INVENTION

The invention relates to a method for adhesively bonding wood materials, wherein a 1K polyurethane adhesive is applied onto a substrate half and is then adhesively bonded by pressing against the second substrate, wherein an activation occurs by increased temperature during the bonding. A high initial adhesion is achieved and the adhesive increases in volume such that irregularities on the substrate sides facing one another are leveled out and a smooth surface is obtained.

### BACKGROUND

Two component polyurethane adhesives are described in EP 1 366 132 which describe/comprise 10 to 98% of an oleochemical polyol, 1 to 7.5% of a diol having an OH number from 400 to 2000, 1 to 7.5% of a polyol having an OH number from 200 to 2000 and at least one polyisocyanate. Two component polyurethane adhesives for adhesively bonding wood materials are described in DE 4401 572 A1; said adhesives are based on an isocyanate component and a polyol component that in addition to an oleochemical polyol comprises 2 to 7 weight percent, based on the oleochemical polyol, of at least one di- and/or trihydric alcohol. 2K PU adhesives of this type require an exact dosing of the ingredients and have only a limited processing time.

One component polyurethane adhesives for wood components are also known. Thus, in DE 44 12 759 A1, an adhesive is described that is characterized by a content of 50 to 95 wt. % of an isocyanate-containing polyurethane prepolymer, 2 to 8 wt. % of a hydrophobic silicon dioxide and 2 to 6 wt. % of a powdered molecular sieve as well as by optional additional conventional additives and/or accelerators. The minimum molding time in order to achieve the initial adhesion is 9 hours. This is very long. In general, the short molding times of two component adhesives based on PU are not achieved with one component polyurethane adhesives. 1K reactive PU hot melt adhesives are described in DE 4429679 which comprise inter alia prepolymers of isocyanates and polyols, wherein castor oil derivatives can also be comprised. The hot melt adhesives set immediately after application at increased temperature.

The 1K or 2K polyurethane adhesives from the prior art have various disadvantages. 2K PU adhesives have to be carefully mixed and thereupon have only a limited processing time. 1K PU adhesives often react very slowly and require a lengthy molding time. Moreover, these adhesives are moisture-sensitive, even to air humidity, and consequently are only storage stable for a short time after application. On extended storage before adhesion they lose their adhesive properties and their reactivity.

A further disadvantage of the known adhesives is that they are generally applied in a thin layer in order to ensure a good adhesion. If the substrates have distinctly uneven surfaces, then the adhesive just cannot fill these spaces. With rigid substrates, there remain cavities that weaken the strength of the adhesive bond. If a substrate is thin and flexible, then the uneven surface of such substrates is often pressed through such that the unevenness of the substrate is visible for example on a bonded film. In contrast, if greater amounts of the adhesive are applied then the problem arises that the excess adhesive has to be leveled and possibly leaks out of the sides of the adhesive bond. This causes contamination of the bonded object or of the equipment used. Apart from that, the cohesion of thick adhesive layers—particularly for foamed glued joints—is often poor.

### SUMMARY OF THE INVENTION

Accordingly, the object of the invention was to provide a method permitting a simple application of a one component polyurethane adhesive having a long processing time and that can make up for possible unevenness of the substrate surface on bonding.

According to the invention, the object is achieved by referring to the claims. It concerns the provision of a method, in which a moisture curing 1K polyurethane adhesive is applied at a low temperature and which has only a low reactivity during and after its application. The coated substrate can optionally be stored; after the bonding and pressing with a second substrate and a crosslinking at increased temperature, there then results a high-strength adhesive bond. The adhesive foams slightly during the crosslinking reaction, thereby enabling the height differences between the substrate surfaces to be equalized and a smooth surface to be obtained.

Another subject matter of the invention is moisture reactive 1K polyurethane adhesives that do not foam after application, after thermal activation adhesively bond with foaming. Here the 1K polyurethane adhesive based on a prepolymer comprising isocyanate groups consists of the reaction product of
20 to 50 parts by weight of at least one oleochemical polyol,
0 to 15 parts by weight of a polyol based on polyethers or polyesters,
80 to 40 parts by weight of a polyisocyanate,
optional additives
   wherein the sum of the fractions should make up 100%.

Another subject matter concerns storage stable adhesive layers on substrates made of wood materials involving the use of the abovementioned adhesives. Oleochemical polyols are understood to mean polyols based on natural oils and fats, e.g. the reaction products of epoxidized fats with mono, di or polyhydric alcohols or glycerine esters of long chain fatty acids that are at least partially substituted with hydroxyl groups. A subgroup of these compounds is the ring-opening products of epoxidized triglycerides, i.e. epoxidized fatty acid glycerine esters, in which the ring opening has been carried out with the conservation of the ester bonds. A great number of epoxidized triglycerides of vegetal or animal origin can be used as starting materials for manufacturing the ring opening products. Thus, for example, epoxidized triglycerides that contain 2 to 10 weight percent epoxide oxygen are suitable. These types of products can be manufactured by the epoxidation of the double bonds of a series of fats and oils, e.g. beef tallow, palm oil, peanut oil, rapeseed oil, cotton seed oil, soya oil, sunflower oil and linseed oil. Particularly preferred epoxidized triglycerides are epoxidized soya oil and epoxidized linseed oil.

### DETAILED DESCRIPTION OF THE INVENTION

Methanol, ethanol, propanol, isopropanol, butanol, hexanol, 2-ethylhexanol, fatty alcohols containing 6 to 22 carbon atoms, cyclohexanol, benzyl alcohol, 1,2-ethanol, 1,2-propane diol, 1,3-propane diol, 1,4-butane diol, 1,6-hexane diol, neopentyl glycol, trimethylolpropane, glycerine, trimethylolethane, pentaerythritol, sorbitol as well as ether group-containing hydroxy compounds such as alkyl glycols or oligomeric glycols as well as oligomeric glycerines can be employed as the alcohols for the ring opening of the epoxidized triglycerides.

The ring opening reaction of epoxidized fatty acid ester or triglyceride with an alcohol can optionally be followed by a transesterification with itself or with other, subsequently added triglycerides, such as for example palm oil, peanut oil, rapeseed oil, cotton seed oil, soya oil, sunflower oil and linseed oil. Such oleochemical polyols are described for example in the German patent application DE-A 41 28 649.

Another group of oleochemical polyols are ring opening and transesterification products of epoxidized fatty acid esters of lower alcohols, i.e. of methyl, ethyl, propyl or butyl esters of epoxidized fatty acids. The ring opening or transesterification products with alcohols with a functionality of 2 to 4 are preferred, especially the transesterification products with ethylene glycol, propylene glycol, oligomeric ethylene glycols, oligomeric propylene glycols, glycerine, trimethylolpropane or pentaerythritol. Such products can be manufactured by known epoxidation processes or ring opening processes, wherein the transesterification can be carried out during or after the ring opening step by removing the lower alcohol from the reaction equilibrium. Ring opening and transesterification products are preferred, in which a molar ratio between epoxidized fatty acid ester and the alcohol used for transesterification was from 1:1 to 1:10.

Similarly to the oleochemical polyols, the transesterification products of epoxidized fatty alcohols with C₂-C₈ alcohols of a functionality 1 to 10, especially 2 to 4, comprise a molar ratio of epoxy groups to the hydroxyl groups of 1:1 to 1:10.

In the context of the invention, the use of oleochemical polyols that can be obtained from the transesterification of di- or polyhydric alcohols such as e.g. from the addition product of ethylene oxide or propylene oxide on glycerine with triglycerides such as palm oil, peanut oil, rapeseed oil, cotton seed oil, soya oil, sunflower oil and linseed oil, is also possible Likewise polyols can be used that can be obtained according to the teaching of DE-A 41 24 665 by the transesterification of polymerized glycerine with the abovementioned triglycerides. Resin-modified oleochemical polyols can also be employed.

The inventively suitable oleochemical polyols can have hydroxyl numbers from 50 to 400, preferably 100 to 250 (mg KOH/g solid).

The use of castor oil or dimer diols as the oleochemical polyols as well as those polyester polyols that are manufactured by the total ring opening of epoxidized triglycerides of a fat mixture comprising at least partially olefinically unsaturated fatty acids with one or more alcohols having 1 to 12 carbon atoms and subsequent partial transesterification of the triglyceride derivatives to alkyl ester polyols having 1 to 12 carbon atoms in the alkyl group is particularly preferred.

The di-, tri- or polyhydric alcohols that are conventionally employed in the polyurethane chemistry and which are known to the person skilled in the art can be employed as the additional polyol components in an inventively suitable polyurethane prepolymer. These concern for example polyalkylene glycols, polyester polyols based on aliphatic or aromatic carboxylic acids, OH-functional polycaprolactone diols, polycarbonate diols obtainable for example by the reaction of low molecular weight diols with diaryl carbonates, or OH group-containing polybutadienes. Such polyols can be used singly or in a mixture.

Exemplary suitable polyol components are polyether polyols known to be based on the reaction products of low molecular polyhydric alcohols with alkylene oxides. Polyether polyols are understood to mean polyols having 2 to 4 OH groups per molecule; they should have an Mₙ (number average molecular weight as determined by GPC) from 300 to 15,000 g/mol. Thus in particular, the reaction products of low molecular weight polyhydric alcohols with alkylene oxides having up to 4 carbon atoms can be employed. Exemplary suitable reaction products are those from ethylene glycol, propylene glycol, the isomeric butane diols or hexane diols with ethylene oxide, propylene oxide and/or butylene oxide or mixtures thereof. Furthermore, the reaction products of trihydric alcohols such as glycerine, trimethylolethane and/or trimethylolpropane or higher hydric alcohols such as for example pentaerythritol or sugar alcohols with the cited alkylene oxides can be employed.

Polyester polyols that can be manufactured by polycondensation are also suitable. These types of polyester polyols preferably include the reaction products of polyhydric, preferably dihydric alcohols, optionally together with minor amounts of trihydric alcohols, and polycarboxylic, preferably dicarboxylic and/or tricarboxylic acids. Instead of free polycarboxylic acids, the corresponding polycarboxylic acid anhydrides or corresponding polycarboxylic acid esters with alcohols having preferably 1 to 3 carbon atoms can also be employed. Hexane diol, 1,4-hydroxymethylcyclohexane, 2-methyl-1,3-propane diol, butane-1,2,4-triol, triethylene glycol, tetraethylene glycol, ethylene glycol, polyethylene glycol, dipropylene glycol, polypropylene glycol, dibutylene glycol and polybutylene glycol are particularly suitable for manufacturing these types of polyester polyols. The polycarboxylic acids can be aliphatic, cycloaliphatic, or aromatic or both. The can be optionally substituted, for example by alkyl groups, alkenyl groups, ether groups or halides. Succinic acid, adipic acid, suberic acid, azelaic acid, sebacic acid, phthalic acid, isophthalic acid, terephthalic acid, trimellitic acid, phthalic anhydride, tetrahydrophthalic anhydride, hexahydrophthalic anhydride, tetrachlorophthalic anhydride, endomethylene tetrahydrophthalic anhydride, glutaric anhydride, maleic acid, maleic anhydride, fumaric acid, dimer fatty acids or trimer fatty acids or mixtures of two or more thereof are suitable exemplary polycarboxylic acids. Minor amounts of monocarboxylic fatty acids can optionally be present in the reaction mixture. In the context of the invention, polyester diols from at least one of the cited dicarboxylic acids and diols that possess terminal OH groups are particularly suitable. Polyesters of this type can be optionally reacted at their terminal groups with alkylene oxide units. The molecular weight should be between 300 and 5000 g/mol, especially less than 2500 g/mol.

However, polyether polyols with a molecular weight of 300-10,000 g/mol, preferably 500-5,000 g/mol are particularly suitable. In this way, depending on the desired molecular weight, addition products of only a few moles of ethylene oxide and/or propylene oxide per mole or even of more than a hundred moles of ethylene oxide and/or propylene oxide on low molecular weight polyhydric alcohols can be employed. Diols or triols are particularly preferred. Polypropylene glycols or polyethylene glycols are particularly suitable. Among the cited polyether polyols, the reaction products of polyhydric low molecular weight alcohols with propylene oxide are particularly suitable under conditions, in which, at least partially, secondary hydroxyl groups are formed.

The amount of the oleochemical polyols should be between 20 and 50 parts by weight. The amount of the polyether polyols or polyester polyols can be between 0 and 15 parts by weight, based on the amount of all prepolymeric ingredients The duration of the possible storage before bonding and activation can also be influenced by the amount of the additional polyols.

In addition, an inventive adhesive can also comprise at least one higher functional low molecular weight polyol. “Low molecular weight” should be understood to mean polyols with a molecular weight between 80 up to 500 g/mol, especially up to 300 g/mol, wherein the functionality should be between 3 to 10. Polyols in this case are those that provide a higher crosslinking of the polymer. Where required, the cohesion of the adhesive can be influenced in this manner. The amount should preferably be less than 5 parts by weight and is chosen such that the prepolymer does not prematurely gel during production. Examples are glycerine, trimethylolethane or trimethylolpropane, pentaerythritol, sugar alcohols or mixtures thereof.

The polyisocyanates are polyfunctional. Preferably, the suitable polyfunctional isocyanates comprise on average 2 to maximum 5, preferably up to 4 and especially 2 or 3 NCO groups. Exemplary suitable isocyanates are phenyl isocyanate, 1,5-naphthylene diisocyanate, 4,4′-diphenylmethane diisocyanate (MDI), hydrogenated MDI (Hi₂MDI), xylene diisocyanate (XDI), tetramethylxylene diisocyanate (TMXDI), 4,4′-diphenyidimethylmethane diisocyanate, di- and tetraalkylene diphenylmethane diisocyanate, 4,4′-dibenzyl diisocyanate, 1,3-phenylene diisocyanate, 1,4-phenylene diisocyanate, the isomers of toluene diisocyanate (TDI), optionally in a mixture, 1-methyl-2,4-diisocyanato cyclohexane, 1,6-diisocyanato-2,2,4-trimethylhexane, 1,6-diisocyanato-2,4,4-trimethylhexane, 1-isocyanatomethyl-3-isocyanato-1,5,5-trimethylcyclohexane (IPDI), phosphorous-containing diisocyanates, tetramethoxybutane-1,4-diisocyanate, butane-1,4-diisocyanate, hexane-1,6-diisocyanate (HDI), dicyclohexylmethane diisocyanate, cyclohexane-1,4-diisocyanate, ethylene diisocyanate, phthalic acid bis-isocyanatoethyl ester or 1,12-diisocyanato dodecane and dimer fatty acid diisocyanate.

In one embodiment the isocyanate component can at least partially comprise dimer fatty acid isocyanate, manufactured from mixtures of predominantly C36 dicarboxylic acids converted into dimer fatty acid isocyanates. Moreover, low molecular weight reaction products of MDI or TDI with low molecular weight mono- to tetrahydric alcohols with a molecular weight of less than 300 can be used, such as e.g. ethylene glycol, diethylene glycol, glycerine, dimethylolpropane, propylene glycol, dipropylene glycol or triethylene glycol.

Aromatic isocyanates with a functionality of ca. 2 to 6, e.g. diphenylmethane diisocyanate, either in the form of the pure isomers, as the isomeric mixture of the 2,4′-/4,4′-isomers or even the diphenylmethane diisocyanate (MDI) liquefied with carbodiimide, as well as the so-called “raw-MDI”, i.e. the mixture of isomers/oligomers of MDI, are preferably used as the di- or polyisocyanates. Likewise, oligomerized adducts having terminal NCO groups made from the above cited isocyanates can be employed with correspondingly polyfunctional low molecular weight polyols, polyamines or aminoalcohols. Monomer-free MDI preparations can also be employed.

The amount of the isocyanate component is more than 40 parts by weight up to 80 parts by weight of aromatic isocyanate, especially between 50 to 75 parts by weight.

The ratio of the isocyanate groups comprised in the isocyanate component to the OH groups comprised in the polyol components is chosen such that there remains an NCO group-containing prepolymer. The resulting prepolymer should comprise between 5 to 30 wt. % NCO groups.

The 1K PU adhesives according to the invention can further comprise auxiliaries and additives. These are understood to mean substances that are generally added in small quantities so as to modify the properties of the adhesive in the desired manner, e.g. its processability, shelf life and also to match application properties to the practical field of use. Suitable auxiliaries can be: fillers, leveling agent, exhausters, thixotropic agents, catalysts, antioxidants, dyes, drying agents, flame retardants, solvents and wetting agents.

Suitable fillers are inorganic compounds that are unreactive to isocyanates such as chalk, coated chalks, lime powder, calcium magnesium carbonates, aluminum oxides and aluminum hydroxides, precipitated silica, zeolites, bentonites, glass, hollow spheres or ground minerals.

The leveling agent is intended to improve the flow of the adhesive during application, i.e. its ability on application to level out resulting unevenness, stripes, bubbles, craters etc. Suitable leveling agents are unreactive compounds such as glycol ethers, silicone oils, acrylate copolymers, polyvinyl derivatives.

The 1K polyurethane adhesives can also comprise catalysts that accelerate the reaction of the OH group with the NCO groups, mainly organometallic compounds, e.g. lead phenyl-ethyl dithiocarbaminate, di-n-octyltin mercaptide, di-n-octyltin bis-dodecylmercaptide, di-n-octyltin dichloride, especially tin(II) salts of carboxylic acids, such as dibutyltin maleate, dibutyltin diacetate, dibutyltin dilaurate, tin(II) acetate, tin(II) ethylhexanoate and tin(II) diethylhexanoate or strong bases such as alkali metal hydroxides, alkali metal alcoholates and alkali metal phenolates.

Aliphatic tertiary amines are likewise suitable, particularly those with a cyclic structure. Under the tertiary amines, those that are also suitable carry additional groups, particularly hydroxyl and/or amino groups, which are reactive towards isocyanates. Examples of these are dimethylmonoethanolamine, diethylmonoethanolamine, methylethylmonoethanolamine, triethanolamine, trimethanolamine, tripropanolamine, tributanolamine, trihexanolamine, tripentanolamine, tricyclohexanolamine, diethanolmethylamine, diethanolethylamine, diethanolpropylamine, diethanolbutylamine, diethanolpentylamine, diethanolhexylamine, diethanolcyclohexylamine, diethanolphenylamine as well as their ethoxylation and propoxylation products, diaza-bicyclo-octane (DABCO), triethylamine, dimethylbenzylamine, bis-dimethylaminoethyl ether, tetramethylguanidine, bis-dimethylaminomethylphenol, 2,2′-dimorpholinodiethyl ether, 2-(2-dimethylaminoethoxy)ethanol, 2-dimethylaminoethyl-3-dimethylaminopropyl ether, bis(2-dimethylaminoethyl) ether, N,N-dimethylpiperazine, N-(2-hydroxyethoxyethyl)-2-azanorbornane, Texacat DP-914, N,N,N,N-tetramethylbutane-1,3-diamine, N,N,N,N-tetramethylpropane-1,3-diamine and N,N,N,N-tetramethylhexane-1,6-diamine.

Such amine catalysts can also be in oligomerized or polymerized form, e.g. as nitrogen-methylated polyethylene imine. Mixtures of the different catalysts can also be used.

Resins of natural or synthetic origin can also be added as additional additives. The natural resins can be of both vegetal and also animal origin, such as shellac and colophonium, tall resins, balsamic resins or root resins. Not only the native natural resins, but also principally their derivatives can be used, be they obtained by disproportionation, dimerization, hydrogenation, polymerization, esterification, salt formation or by the addition of unsaturated compounds e.g. maleic acid.

The synthetic resins are generally obtained by polymerization or polycondensation. Characteristically, they do not have sharp melting points or softening points. Exemplary resins are those based on hydrocarbons, terpenes, coumarone/indene, furans, alkyds, aldehydes, ketones, phenols, glycerine esters, polyesters, epoxides, ureas, melamines, polyamides and isocyanates. The amount of the additive should be less than 10 parts by weight.

Adhesives according to the invention can be manufactured from the abovementioned oleochemically-based polyols, the additional polyols based on polyethers or polyesters and from the appropriate polyisocyanates according to methods and techniques known to the person skilled in the art. The polyols are generally provided singly or in a mixture and optionally dried. This can be carried out by distillation, for example also under vacuum. Moreover, water can also be removed from the polyols by means of water scavengers, such as for example molecular sieves. Minor residual quantities of water, less than 500 ppm, do not further interfere, as generally an excess of isocyanate is processed. Subsequently, the isocyanate or a mixture of a plurality of isocyanates is added to the thus essentially anhydrously prepared polyol mixture. Care should be taken here to ensure a good mixing of the components. The reaction between the OH groups and the isocyanate groups normally begins spontaneously; optionally it can be supported by heating or a minor quantity of catalyst can be added.

The resulting prepolymer contains NCO. Further additives can optionally be added to this mixture. In which case, care should be taken that these additives do not comprise any groups that react with the isocyanate groups. The finished adhesive should have a viscosity between 500 and 150,000 mPas at the application temperature, for example at 30° C., especially between 1000 and 50,000 mPas (measured with Brookfield RVT, 30° C. EN ISO 2555). In the absence of water it is storage stable for any length of time. With the adhesive according to the invention it is possible to spread thin layers of adhesive onto a substrate, which are storage stable for up to 24 hours at room temperature without losing their adhesive properties. These thin layers can subsequently be joined together with other substrates and be crosslinked by activation at increased temperature. This causes the water/the moisture present in the surroundings or in the adhesive to react with the isocyanate groups and the build up of adhesion occurs rapidly. Surprisingly this reaction in thin layers of the adhesive does not take place in the absence of thermal activation even though sufficient atmospheric moisture is present.

The 1K polyurethane adhesives according to the invention are suitable for adhesively bonding a great many solid or flexible substrates. Thus, plastics, metals, glass, particularly wood and wood materials (chipboard, MDF boards) can be adhesively bonded. In particular, non-flexible substrates can be adhesively bonded to each other or flexible film substrates can be adhesively bonded to such rigid substrates. Exemplary suitable flexible substrates are wood veneers, veneer films or multi-layer films. The water content of the substrate is generally not critical; the moisture usually present on the surface is beneficial for a good adhesion and crosslinking. For porous wood materials the moisture content can preferably be in the range 2 to 20 wt. %, especially in the range 4 to 16 wt. %.

To carry out the method according to the invention, a suitable 1K PU adhesive according to the invention is applied onto a substrate. This can be made by methods of the prior art, for example by coating with a doctor blade, spraying, roller coating, extrusion coating or by other methods. The viscosity of the adhesive should be selected such that the method of application affords a uniform layer. For low viscosities a roller coating is particularly suitable, for high viscosities an application by extrusion is more advantageous. The application can optionally be facilitated by heating the adhesive. When required, it is also possible to add inert solvent so as to influence the viscosity; however this technique is less preferred. The application temperature should be less than 50° C., particularly below 40° C., especially at about room temperature of 15 to 30° C. The coating thickness can be up to 750 μm, especially between 10 to 250 μm.

After the liquid adhesive has been applied onto this substrate surface the layer can optionally cool down and if so can gel. There results a thin coating that at room temperature, i.e. at temperatures below 30° C., shows practically neither a crosslinking reaction nor forms bubbles and is storage stable for a period between 30 minutes and 24 hours; in particular this adhesive layer is storage stable for more than 3 hours. The storage conditions are variable. The relative humidity during storage can be up to 95% relative humidity. Optionally it can be required, in order to prevent contamination of the adhesive-coated surface during storage, to cover it with non-adhesive protective film, e.g. based on polymer or with non-stick coated paper.

In the work method according to the invention, after the substrate has been coated, a second substrate, for example another rigid wood substrate or preferably a flexible substrate, especially a wood film or plastic film, is applied. For this, the substrate to be adhesively bonded is applied onto the adhesive-coated substrate surface in a compression device. The composite is compressed prior to the application or preferably at the same time as the adhesive is activated. The activation occurs by heating to a temperature above 50° C., preferably above 70° C., particularly above 80° C. Temperatures above 250° C. are generally unsuitable as they can damage the substrate and require unnecessary energy; in particular the temperature should be les than 200° C. Pressure and elevated temperature are held between 10 seconds and 30 minutes, especially between 1 to 15 minutes. A reaction of the adhesive layer occurs within this time with the water absorbed in the adhesive, the moisture of the substrate or atmospheric moisture. The pressure and elevated temperature can then be removed, the substrates are firmly bonded and can subsequently stored. The strength and dimensional stability of the composites manufactured in this way is already produced at the pressing temperature; a recooling and physical setting to attain adequate strength values is not needed.

Another inventive mode of operation joins a plurality of different or similar substrate layers together, said substrates having an adhesive layer according to the method on one side, which are then pressed together and adhesively bonded. Laminated wood molded objects can be produced in this way.

After application onto a substrate surface, the adhesive layer according to the invention when stored below 40° C., particularly 30° C., neither exhibits crosslinking reactions nor bubble formation as troublesome side reactions. The unactivated adhesive layer does not lose its adhesive action when stored, i.e. the open time of the adhesive up to the final adhesive bonding is long.

However, it is inventively required that when heated to the activation temperature and in the associated compression step, the adhesive foams during the crosslinking. The foam volume is only slight and in particular should be less than 50 volume % of the adhesive. Whereas the density of the inventively non-foamed adhesive is normally ca. 1.00 to 1.20 g/cm³, the density of the crosslinked adhesive can be lower. The foam volume can be determined from the density of the crosslinked adhesive. The density should be between 1.10 down to 0.3 g/cm³, especially between 0.5 up to 0.95 g/cm³. Surprisingly, the slight foaming of an inventively suitable adhesive leads neither to a decrease in cohesion nor in adhesion of the adhesive to the substrates. The adhesively bonded surfaces have a high adhesive strength.

The inventive method is particularly suitable for adhesively bonding thin flexible substrates onto a rigid substrate, for example films based on polymers, wood or composite materials, onto rigid, hard plastic, metal or wood substrates; however, two or more similar substrates can also be adhesively bonded. In this case the surface of the hard substrate does not particularly need to be polished or pre-treated. Possible unevenness or cavities in the surface, for example with a depth of up to 1 mm, are bridged or filled in with a suitable adhesive when the inventive method is used. In this way, a thin, flexible substrate is successfully adhesively bonded to afford a smooth surface and the foam content in the cured adhesive does not impair the strength.

Another subject matter of the invention is a method for applying thin reactive adhesive layers onto substrates by means of calendaring, rolling or coating, wherein the application temperature is below 50° C., especially below 40° C. 1K polyurethane adhesives from the prior art generally have a short open time, i.e. the adhesive reacts even at room temperature with atmospheric moisture. By using an inventive 1K PU adhesive having a long open time, it is possible that the application tooling, for example a coating cylinder, can be continuously operated for a longer length of time without the need for cleaning. According to this mode of operation the application device under normal conditions can come into contact with the inventive adhesive for longer periods, e.g. up to 24 hours. The adhesive does not react with atmospheric moisture, premature crosslinking reactions do not occur and the application device is not contaminated. It is sufficient to clean with greater periodic intervals as no gel formation or protrusions appear in the moisture-curing adhesive. Accordingly, the inventive method is particularly suitable for a continuous application process.

The adhesive bonds according to the inventive method are characterized by an unusually high strength and resistance against moisture. Possible unevenness of a substrate surface is compensated for by an inventive mode of operation and a second thin flexible substrate layer can be adhesively bonded onto the first uneven substrate. The adhesively bonded substrates from the inventive method possess a very smooth surface. Due to the long open time, no contaminants appear on the application device. Moreover, the occurrence of premature gel is not observed in the adhesive film.

### EXAMPLES

### Example 1

10 parts of a polyether diol based on propylene glycol with an Mₙ of ca. 2000 were dried under vacuum. To this diol were added a further 30 parts of an oleochemical polyol with an Mₙ of ca. 1000 and an OH number of ca. 200. To this mixture were added 60 parts of crude MDI (Isonate 143 L). The mixture was homogenized and stirred at a temperature of 75° C. for 30 minutes. An adhesive was obtained with a NCO content of 16% and a viscosity of 10,000 mPas at 30° C.

### Example 2

39.5 parts of an oleochemical polyol with an Mₙ of 1000 and an OH number of 200 were freed from water under a vacuum. 0.5 parts of pentaerythritol were added. To this mixture were added 60 parts of crude MDI. 0.01% DBTL were added as catalyst, the mixture was homogenized and allowed to react for one hour at 50° C. An adhesive was obtained with a viscosity of 50,000 mPas at 30 ° C. and an isocyanate content of 17%.

### Example 3

25 parts of an oleochemical polyol with an Mₙ of ca. 1000 and an OH number of ca. 200 were dried. To this mixture were added 75 parts of crude MDI (Isonate 143 L). The mixture was homogenized and stirred at a temperature of 75° C. for 30 minutes. An adhesive was obtained with a NCO content of 20% and a viscosity of 20,000 mPas at 30° C.

### Adhesive Bonding:

1) A beech wood object was cleaned to remove adherent dust constituents. An adhesive according to examples 1 to 3 was then applied with a coating layer of ca. 50 μm with a knife blade at room temperature (25° C.). After cooling the substrate, a storage stable coating was obtained. An aluminum test piece was coated in the same way.

The coated substrates were adhesively bonded with a corresponding substrate. The adhesively bonded substrates were then subjected to a pressure of 10-100 kg/m² in a press, the work piece being simultaneously heated to 150° C. The pressure and temperature were maintained for 10 minutes.

The tensile shear strength of the adhesively bonded products was greater than 6 N/mm². Similar values were obtained when the test pieces had been stored for 5 hours at room temperature before bonding. In that case the adhesive surface was not foamed.

2) The abovementioned wood specimens were coated in the same way. A paper film or CPL film was applied and the adhesively bonded specimen was pressed and heated for 5 minutes at 100° C.

The resulting product exhibited a smooth surface and unevenness of the substrate was not displayed.

In a comparative experiment, a commercial adhesive of the type Macromelt UR 7221 (Henkel KgaA) based on an isocyanate-crosslinking polyurethane was applied. The coating thickness on the wood specimen was also 50 μm.

After storage for 2 hours, the exposed surfaces exhibited foam formation on the surface.

After storage, the substrate was adhesively bonded with a wood object for 10 minutes at 150° C.; the tensile shear strength was less than 4.0 N/mm². An appropriate paper film or CPL film was adhesively bonded, compressed and heated. The surface defects became apparent.

1. A process for bonding flat substrates with a moisture-crosslinkable one component polyurethane-based adhesive comprising:
a) applying the adhesive onto a first substrate at temperature below 50° C.;
b) optionally, storing the coated substrate;
c) bringing a second substrate in contact with the adhesive coated on the first substrate;
d) curing the adhesive at temperature of 50° C. and 250° C.;
wherein the adhesive foams during curing.

2. The process according to claim 1, wherein the adhesive has a viscosity between 500 and 150,000 mPas at 30° C.

3. The process according to claim 1, wherein the adhesive is applied at a temperature of 15° C. to 40° C.

4. The process according to claim 1, wherein the curing of the adhesive is at a temperature of 70° C. to 200° C.

5. The process according to claim 1, wherein step d is conducted from 10 seconds to 30 minutes.

6. The process according to claim 1, wherein the substrates are selected from the group consisting of plastic film, wood and composites.

7. The process according to claim 6, wherein the surface of the substrate is uneven.

8. The process according to claim 1, wherein an adhesive is applied at room temperature and air humidity of up to 95%.

9. The process according to claim 1, wherein the adhesive, after curing, has a density between 0.3 g/cm³ up to 1.10 g/cm³.

10. The process according to claim 1, wherein step b occurs for a period of 0.5 to 24 hours at a temperature below 30° C.

11. The process according to claim 1 wherein the curing is conducted with a heatable cylinder.

12. The process according to claim 10, wherein the curing conducted with a heatable press.

13. The process according to claim 1, wherein in step b, the applied adhesive has an open time greater than 3 hours at room temperature.

14. A liquid, moisture-curable one component polyurethane adhesive comprising:
a) a reaction product of 20 to 50 parts by weight of an oleochemical polyol,
b) 0 to 15 parts by weight of a polyether polyol or polyester polyol with an Mₙ between 300 and 15000; and
c) 80 to 40 parts by weight of a polyisocyanate;
wherein the adhesive can be stored in thin layers at room temperature for 1 to 24 hours and subsequently crosslink at a temperature of 70 to 200° C.

15. The adhesive according to claim 14, which after crosslinking, has a density between 0.30 g/cm³ to 1.10 g/cm³.

16. The adhesive according to claim 14, wherein and the polyisocyanate is 50 to 75 parts by weight.

17. The adhesive according to one of claim 14, wherein the polyol is a castor oil or polypropylene glycol and the polyisocyanate is aromatic isocyanate.

18. The adhesive according to claim 14, wherein the adhesive comprises a polyol with a functionality of 3 to 10, and a catalyst.

19. The adhesive according to 14, wherein the open time of the adhesive is greater than 3 hours at a temperature below 50° C.
